(19) United States
(12) Patent Application Publication
(10) Pub. No.: US 2020/0345002 A1
(43) Pub. Date: Nov. 5, 2020

(54) COMPOSITIONS AND METHODS FOR INDUCING CROP CHANGES BY LEVERAGING THE EFFECTS OF AN APPLIED AGRICULTURAL CHEMICAL

(71) Applicant: ADVANCED BIOLOGICAL MARKETING, INC., Geneva, NY (US)

(72) Inventor: Molly Cadle-Davidson, Geneva, NY (US)

(73) Assignee: ADVANCED BIOLOGICAL MARKETING, INC., Geneva, NY (US)

(21) Appl. No.: 16/762,484

(22) PCT Filed: Nov. 21, 2018
(86) PCT No.: PCT/US2018/062303

§ 371 Date: May 7, 2020

Related U.S. Application Data
(60) Provisional application No. 62/589,365, filed on Nov. 21, 2017.

(51) Int. Cl. A01N 25/32

(52) U.S. Cl. CPC A01N 25/32; A01N 63/27

(57) ABSTRACT

The present disclosure relates generally to compositions, methods and systems entailing one or more microbial agents' or their derivatives being applied to crop plants such that changes in. plant gene expression are induced that either mitigate or leverage the effects of an applied agricultural chemical including induction of herbicide resistance on an otherwise herbicide susceptible plant. The present disclosure allows for the use of. non-GMO plants in combination with microbial agents or derivatives that signal the plant to combat the effects of the herbicide. Thus, possible transfer of herbicide. resistance genes to weed populations is. elini&tated. and the use of different microbe-herbicide combinations an sequential crops, resulting in the ability to improve the usefulness of a given herbicide.

### RELATED APPLICATIONS

This application is related to U.S. Provisional Application Ser. No. 62/589,365, filed Nov. 21, 2017 entitled “Method of induced crop changes that mitigate or leverage the effects of an applied agricultural chemical and use of same”, which is incorporated by reference herein in its entirety.

### STATEMENT REGARDING FEDERALLY SPONSORED RESEARCH OR DEVELOPMENT

Not Applicable.

### STATEMENT REGARDING PARTIES TO A JOINT RESEARCH AGREEMENT

Not Applicable.

### REFERENCE TO SEQUENCE LISTING, TABLE, OR COMPUTER PROGRAM LISTING

Not Applicable.

### STATEMENT REGARDING PRIOR DISCLOSURES BY THE INVENTOR OR A JOINT INVENTOR UNDER 37 C.F.R. 1.77(B)(6)

Not Applicable.

### TECHNICAL FIELD

The present technology relates generally to compositions, methods and systems entailing one or more microbial agents or their derivatives being applied to crop plants.

### BACKGROUND ART

The following description is provided to assist the understanding of the reader. None of the information provided or references cited is admitted to be prior art to the present invention.

Some microbial agents are known to alter plant gene expression via their colonization of plant roots and/or shoots. Changes in plant gene expression can be in root tissue, shoot tissue, or both, and effect the plant phenotypes expressed regardless of what part of the plant is colonized. A set of plant genes known to be upregulated by some microbial agents are those in the Reactive Oxygen (ROS) Cycling pathway resulting in a greater number of protein copies from these genes when sufficient nutrients are available to plants to accommodate such increases in protein synthesis. This increase in ROS cycling capacity allows plants to better mediate stresses such as drought, heat, and salt since these stresses are all ROS generating stresses.

Antagonistic to this, certain agricultural herbicides available today, such N,N′-dimethyl-4,4′-bipyridinium dichloride (paraquat), interact with plant Photosystem I to produce ROS and spawn a cycle of intracellular oxidative damage. Plants with no ability to boost their ROS cycling pathway and thereby mitigate higher levels of ROS due to Paraquat treatment are completely susceptible to this herbicide. However, colonization of plants with microbial agents that upregulate all the genes in the ROS cycling pathway enables those plants to regulate the additional ROS generated by herbicides such as paraquat. Herbicides in general must target plant cell function(s) in some fashion in order to achieve killing. Microbes interact with plants through chemical signals that are known to alter plant gene expression and physiology and can therefore alter plant cell functions.

Thus, generally speaking, it can be expected that a plant microbial colonist could alter plant cell function such that the cellular target(s) of an herbicide could be buffered or otherwise protected to achieve either partial or complete herbicide resistance. This microbe-plant-herbicide interaction allows for the deployment of microbially-protected crop plants that can survive herbicide sprays, thus enabling chemical weed control in conventional crop settings.

### SUMMARY

The present invention relates generally to compositions, methods and systems entailing one or more microbial agents or their derivatives being applied to crop plants such that changes in plant gene expression are induced that either mitigate or leverage the effects of an applied agricultural chemical including induction of herbicide resistance on an otherwise herbicide susceptible plant. Current methods for imbuing herbicide resistance on a plant include use of paired herbicides on plants genetically modified to be resistant to those herbicides (GMO). Development of resistant weed species, including via transfer of these herbicide resistance genes to weed populations and rotation with different crops that contain these same resistance genes are leading to reduced efficacy of such herbicides.

The present invention allows for the use of non-GMO plants in combination with microbial agents or derivatives that signal the plant to combat the effects of the herbicide. Thus, possible transfer of herbicide resistance genes to weed populations is eliminated and the use of different microbe-herbicide combinations on sequential crops, resulting in the ability to improve the usefulness of a given herbicide. Many chemicals are currently applied to crop plants for a variety of reasons, and the present invention could be used to augment plant performance, via microbe or microbial derivative treatment, in the presence of agricultural chemicals or to alter the activity of said agricultural chemicals on the target or non-target plants.

The present technology relates generally to compositions, methods and systems entailing one or more microbial agents or their derivatives being applied to crop plants such that changes in plant gene expression are induced that either mitigate or leverage the effects of an applied agricultural chemical. One of many possible examples of this is the use of Trichoderma and/or Bacillus strains to colonize plant roots and increase plant expression of the genes in the Reactive Oxygen Cycling (ROS) pathway. This is the plant process that is attacked by the herbicide paraquat. The use of this biological plus paraquat pairing in field applications mitigates the effects of the herbicide on colonized plants thus rendering them herbicide tolerant without the use of a GMO crop.

The embodiments disclosed in this application to achieve the above-mentioned object has various aspects, and the representative aspects are outlined as follows. With parenthetical reference to the corresponding parts, portions or surfaces of the disclosed embodiment, merely for the purposes of illustration and not by way of limitation, the present invention provides a composition comprising one or more microbes in combination with one or more agricultural chemicals, wherein said agricultural chemicals include any multiple or combination of fungicide, insecticide, nematicide, bacteriocide, herbicide, or other chemicals commonly applied on the seed, in furrow, soil drench, root dip, foliar spray, side dress, or other by other means to a crop, wherein said one or more microbes are Trichoderma virens, Trichoderma atroviride, Trichoderma strains K1, K2, K3, K4, or K5, and/or some combination thereof.

Further provided is a composition comprising one or more microbe-derived compounds in combination with one or more agricultural chemicals, wherein said agricultural chemicals include any multiple or combination of fungicide, insecticide, nematicide, bacteriocide, herbicide, or other chemicals commonly applied on the seed, in furrow, soil drench, root dip, foliar spray, side dress, or other by other means to a crop, wherein said one or more microbe-derived compounds are metabolites including 6-pentyl pyrone, harzianic acid, hydtra 1, harzinolide and/or 1-octene-3-ol, and further including one or more microbes, wherein said one or more microbes are Trichoderma virens, Trichoderma atroviride, Trichoderma strains K1, K2, K3, K4, or K5, and/or some combination thereof.

Also provided is a composition comprising one or more microbes, plus one or more microbe-derived compounds in combination with one or more agricultural chemicals, wherein said agricultural chemicals include any multiple or combination of fungicide, insecticide, nematicide, bacteriocide, herbicide, or other chemicals commonly applied on the seed, in furrow, soil drench, root dip, foliar spray, side dress, or other by other means to a crop, wherein said one or more microbes are Trichoderma virens, Trichoderma atroviride, Trichoderma strains K1, K2, K3, K4, or K5, and/or some combination thereof, wherein said one or more microbe-derived compounds are metabolites including 6-pentyl pyrone, harzianic acid, hydtra 1, harzinolide and/or 1-octene-3-ol.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

FIG. 1 depicts gene regulation (circled) of the water-water cycle in chloroplasts.

FIG. 2 depicts gene regulation (circled) of a sequence of cycles (1) the Glutathione ascorbate cycle, (2) the GPX cycle, and (3) the Catalase cycle.

FIG. 3 is an overview of the influence of Paraquat type herbicides and microbial agents (Trichoderma as an example) on plant ROS regulation.

FIG. 4 is the diagrammatic output of BLAST2GO analysis of RNAseq data showing that genes in the reactive oxygen cycling pathway are upregulated using a formulation comprising a combination of T. afroharzianum, ATCC PTA9708 and T. atroviridae, ATCC PTA9707.

FIG. 5 is a graph showing the response of plant tissue to Methyl Violagen (MV; paraquat) treatment following root colonization by microbial agents or seed treatment with microbial metabolites. The boxes show the fold increase in solution conductivity as a result of membrane leakage due to MV exposure. The control (no microbial colonization or metabolite treatment) shows significantly increased leakage or cellular damage compared to the colonized or metabolite treated plants.

FIG. 6 demonstrates recovery of greenhouse plants from gh spray of paraquat. The control is in the lower left and the remaining plants are colonized with single Trichoderma strains, with 3 replicate plants per strain. This figure is six hour post Paraquat spray.

FIG. 7 Demonstrates recovery of greenhouse plants from gh spray of paraquat at 24 hours post spray. Plants in the pink cordoned area show the complete killing effect of the Paraquat application on a weedy target.

FIG. 8 shows recovery of replicates of plants using the present invention. The control is in the upper left and the remaining plants are colonized with single Trichoderma strains, with 3 replicate plants per strain.

### DESCRIPTION OF THE PREFERRED EMBODIMENTS

It is to be appreciated that certain aspects, modes, embodiments, variations and features of the invention are described below in various levels of detail in order to provide a substantial understanding of the present invention.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

In practicing the present invention, many conventional techniques in molecular biology, protein biochemistry, cell biology, immunology, microbiology and recombinant DNA are used. These techniques are well-known and are explained in, e.g., Current Protocols in Molecular Biology, Vols. I-III, Ausubel, Ed. (1997); Sambrook et al., Molecular Cloning: A Laboratory Manual, Second Ed. (Cold Spring Harbor Laboratory Press, Cold Spring Harbor, N.Y. (1989)); DNA Cloning: A Practical Approach, Vols. I and II, Glover, Ed. (1985); Oligonuchotide Synthesis, Gait, Ed. (1984); Nucleic Acid Hybridization, Hames & Higgins, Eds. (1985); Transcription and Translation, Hames & Higgins, Eds. (1984); Animal Cell Culture, Freshney, Ed. (1986); Immobilized Cells and Enzymes (IRL Press, 1986); Perbal, A Practical Guide to Molecular Cloning; the series, Meth. Enzymol., (Academic Press, Inc., 1984); Gene Transfer Vectors for Mammalian Cells, Miller & Calos, Eds. (Cold Spring Harbor Laboratory, New York (1987)); and Meth. Enzymol., Vols. 154 and 155, Wu & Grossman, and Wu, Eds., respectively. Methods to detect and measure levels of polypeptide gene expression products (i.e., gene translation level) are well-known in the art and include the use polypeptide detection methods such as antibody detection and quantification techniques. (See also, Strachan & Read, Human Molecular Genetics, Second Edition. (John Wiley and Sons, Inc., New York (1999).)

Unless defined otherwise, all technical and scientific terms used herein generally have the same meaning as commonly understood by one of ordinary skill in the art to which this invention belongs. As used in this specification and the appended claims, the singular forms “a,” “an” and “the” include plural referents unless the content clearly dictates otherwise. For example, reference to “a cell” includes a combination of two or more cells, and the like. Generally, the nomenclature used herein and the laboratory procedures in cell culture, molecular genetics, organic chemistry, analytical chemistry and nucleic acid chemistry and hybridization described below are those well-known and commonly employed in the art. All references cited herein are incorporated herein by reference in their entireties and for all purposes to the same extent as if each individual publication, patent, or patent application was specifically and individually incorporated by reference in its entirety for all purposes.

In practicing the present invention, many conventional techniques in molecular biology, protein biochemistry, cell biology, immunology, microbiology and recombinant DNA are used. These techniques are well-known and are explained in, e.g., Current Protocols in Molecular Biology, Vols. I-III, Ausubel, Ed. (1997); Sambrook et al., Molecular Cloning: A Laboratory Manual, Second Ed. (Cold Spring Harbor Laboratory Press, Cold Spring Harbor, N.Y., 1989); DNA Cloning: A Practical Approach, Vols. I and II, Glover, Ed. (1985); Oligonucleotide Synthesis, Gait. Ed. (1984); Nucleic Acid Hybridization, Hames & Higgins, Eds. (1985); Transcription and Translation, Hames & Higgins, Eds. (1984); Animal Cell Culture, Freshney, Ed. (1986); Immobilized Cells and Enzymes (IRL Press, 1986); Perbal, A Practical Guide to Molecular Cloning; the series, Meth. Enzymol., (Academic Press, Inc., 1984); Gene Transfer Vectors for Mammalian Cells, Miller & Calos, Eds. (Cold Spring Harbor Laboratory, N Y, 1987); and Meth. Enzymol., Vols. 154 and 155, Wu & Grossman, and Wu, Eds., respectively.

### Definitions

The definitions of certain terms as used in this specification are provided below. Definitions of other terms may be found in the Illustrated Dictionary of Immunology, 2nd Edition (Cruse, J. M. and Lewis, R. E., Eds., Boca Raton, Fla.: CRC Press, 1995). Unless indicated otherwise, the term “biomarker” when used herein refers to the human biomarker, e.g., a human protein and gene. Such definitions of certain terms as used in this specification are provided below. Unless defined otherwise, all technical and scientific terms used herein generally have the same meaning as commonly understood by one of ordinary skill in the art to which this invention belongs.

As used in this specification and the appended claims, the singular forms “a” “an” and “the” include plural referents unless the content clearly dictates otherwise. For example, reference to “a cell” includes a combination of two or more cells, and the like.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the enumerated value.

As used herein, the “administration” of an agent, microbe, compositions, drug, or peptide to a subject plant and/or plant system includes any route or modality of introducing or delivering the agent or composition to perform its intended function.

As used herein, the term “amino acid” includes naturally-occurring amino acids and synthetic amino acids, as well as amino acid analogs and amino acid mimetics that function in a manner similar to the naturally-occurring amino acids. Naturally-occurring amino acids are those encoded by the genetic code, as well as those amino acids that are later modified, e.g., hydroxyproline, γ-carboxyglutamate, and O-phosphoserine. Amino acid analogs refers to compounds that have the same basic chemical structure as a naturally-occurring amino acid, i.e., an α-carbon that is bound to a hydrogen, a carboxyl group, an amino group, and an R group, e.g., homoserine, norleucine, methionine sulfoxide, methionine methyl sulfonium. Such analogs have modified R groups (e.g., norleucine) or modified peptide backbones, but retain the same basic chemical structure as a naturally-occurring amino acid. Amino acid mimetics refers to chemical compounds that have a structure that is different from the general chemical structure of an amino acid, but that functions in a manner similar to a naturally-occurring amino acid. Amino acids can be referred to herein by either their commonly known three letter symbols or by the one-letter symbols recommended by the IUPAC-IUB Biochemical Nomenclature Commission.

As used herein, the terms “amplification” or “amplify” mean one or more methods known in the art for copying a target nucleic acid, e.g., biomarker mRNA, thereby increasing the number of copies of a selected nucleic acid sequence. Amplification may be exponential or linear. A target nucleic acid may be either DNA or RNA. The sequences amplified in this manner form an “amplicon.” While the exemplary methods described hereinafter relate to amplification using the polymerase chain reaction (PCR), numerous other methods are known in the art for amplification of nucleic acids (e.g., isothermal methods, rolling circle methods, etc.). The skilled artisan will understand that these other methods may be used either in place of, or together with, PCR methods. See, e.g., Saiki, “Amplification of Genomic DNA” in PCR Protocols, Innis et al., Eds., Academic Press, San Diego, Calif. 1990, pp. 13-20; Wharam et al., Nucleic Acids Res., 2001, 29(11):E54-E54; Hafner et al., Biotechniques 2001, 30(4):852-6, 858, 860); Zhong et al., Biotechniques, 2001, 30(4):852-6, 858, 860.

As used herein, the term “aggregation” or “cell aggregation” refers to a process whereby biomolecules, such as polypeptides, or cells stably associate with each other to form a multimeric, insoluble complex, which does not disassociate under physiological conditions unless a disaggregation step is performed.

As used herein, the terms “amphipathic” or “amphiphilic” are meant to refer to any material that is capable of polar and non-polar, or hydrophobic and hydrophilic, interactions. These amphipathic interactions can occur at the same time or in response to an external stimuli at different times. For example, when a specific material, coating, a linker, matrix or support, is said to be “amphipathic,” it is meant that the coating can be hydrophobic or hydrophilic depending upon external variables, such as, e.g., temperature.

As used herein, the phrase “difference of the level” refers to differences in the quantity of a particular marker, such as a cell surface antigen, biomarker protein, nucleic acid, or a difference in the response of a particular cell type to a stimulus, e.g., a change in surface adhesion, in a sample as compared to a control or reference level. In illustrative embodiments, a “difference of a level” is a difference between the level of a marker present in a sample as compared to a control of at least about 1%, at least about 2%, at least about 3%, at least about 5%, at least about 10%, at least about 15%, at least about 20%, at least about 25%, at least about 30%, at least about 35%, at least about 40%, at least about 50%, at least about 60%, at least about 75%, at least about 80% or more.

As used herein, the terms “expression” or “gene expression” refer to the process of converting genetic information encoded in a gene into RNA, e.g., mRNA, rRNA, tRNA, or snRNA, through transcription of the gene, i.e., via the enzymatic action of an RNA polymerase, and for protein encoding genes, into protein through translation of mRNA. Gene expression can be regulated at many stages in the process. “Up-regulation” or “activation” refers to regulation that increases the production of gene expression products, i.e., RNA or protein, while “down-regulation” or “repression” or “knock-down” refers to regulation that decreases production. Molecules, e.g., transcription factors that are involved in up-regulation or down-regulation are often called “activators” and “repressors,” respectively.

As used herein, the term “composition” refers to a product with specified ingredients in the specified amounts, as well as any product which results, directly or indirectly, from combination of the specified ingredients in the specified amounts.

As used herein, the terms “produce”, “crops”, “food component” “system component”, “augmentation variable” or “subject” refer to a plant, fungus, microbial colony, mammal, such as a human, but can also be another animal such as a domestic animal, e.g., a dog, cat, or the like, a farm animal, e.g., a cow, a sheep, a pig, a horse, or the like, or a laboratory animal, e.g., a monkey, a rat, a mouse, a rabbit, a guinea pig, or the like.

As used herein, the terms “matrix” or “support” or “hydrogel matrix” are used interchangeably, and encompass polymer and non-polymer based hydrogels, including, e.g., poly(hyaluronic acid), poly(sodium alginate), poly(ethylene glycol), diacrylate, chitosan, and poly(vinyl alcohol)-based hydrogels. “Hydrogel” or “gel” is also meant to refer to all other hydrogel compositions disclosed herein, including hydrogels that contain polymers, copolymers, terpolymer, and complexed polymer hydrogels, i.e., hydrogels that contain one, two, three, four or more monomeric or multimeric constituent units. Hydrogels are typically continuous networks of hydrophilic polymers that absorb water.

As used herein, the term “reference level” refers to a level or measurement of a substance or variable which may be of interest for comparative purposes. In some embodiments, a reference level may be a specified moisture content as an average of the moisture content taken from a control subject/plant. In other embodiments, the reference level may be the level in the same subject/plant at a different time, e.g., a time course of administering or applying a particular composition or formulation.

As used herein, the terms “treating” or “treatment” or “alleviation” refer to both therapeutic treatment and prophylactic or preventative measures, where the objective is to prevent or slow down (lessen) the targeted disease, condition or disorder. A plant is successfully “treated” for a disorder if, after receiving therapeutic intervention/application according to the methods of the present invention, the subject/plant shows observable and/or measurable reduction in or absence of one or more targeted disease, condition or disorder.

An “isolated” or “purified” polypeptide or peptide is substantially free of cellular material or other contaminating polypeptides from the cell or tissue source from which the agent is derived, or substantially free from chemical precursors or other chemicals when chemically synthesized. For example, an isolated aromatic-cationic peptide would be free of materials that would interfere with diagnostic or therapeutic uses of the agent. Such interfering materials may include enzymes, hormones and other proteinaceous and nonproteinaceous solutes.

As used herein, the terms “polypeptide”, “peptide” and “protein” are used interchangeably herein to mean a polymer comprising two or more amino acids joined to each other by peptide bonds or modified peptide bonds, i.e., peptide isosteres. Polypeptide refers to both short chains, commonly referred to as peptides, glycopeptides or oligomers, and to longer chains, generally referred to as proteins, Polypeptides may contain amino acids other than the 20 gene-encoded amino acids. Polypeptides include amino acid sequences modified either by natural processes, such as post-translational processing, or by chemical modification techniques that are well known in the art.

As used herein, the term “simultaneous” use refers to the administration of at least two active ingredients by the same route and at the same time or at substantially the same time.

As used herein, the term “separate” use refers to an administration of at least two active ingredients at the same time or at substantially the same time by different routes.

As used herein, the term “sequential” use refers to administration of at least two active ingredients at different times, the administration route being identical or different. More particularly, sequential use refers to the whole administration of one of the active ingredients before administration of the other or others commences. It is thus possible to administer one of the active ingredients over several minutes, hours, or days before administering the other active ingredient or ingredients. There is no simultaneous treatment in this case.

As used herein, the term “p-value” or “p” refers to a measure of probability that a difference between groups happened by chance. For example, a difference between two groups having a p-value of 0.01 (or p=0.01) means that there is a 1 in 100 chance the result occurred by chance. In illustrative embodiments, suitable p-values include, but are not limited to, 0.1, 0.05, 0.025, 0.02, 0.01, 0.005, 0.001, and 0.0001. In suitable embodiments, and throughout the Examples provided herein, letters of significance are at P=0.10 with the R studio interface.

The present invention relates to, inter alia, the discovery and development of a biological system for protection of plants against herbicide or other sprays targeting plant protein, biochemical, enzymatic, or metabolic activity. More generally, it describes a method of delivering an agriculturally relevant signal via colonization by a microbial symbiont. This signal can then be leveraged to change host plant gene expression resulting in resistance to agricultural chemicals such as herbicides, augmented performance in combination with pesticides, augmented or novel performance in combination with ripening or post-harvest quality agents, or heightened or superior performance in combination with other agricultural chemicals.

The concepts underlying the induction of stress resistance in plants are unique. Plants suffer from accumulation of (ROS) as a consequence of stress, such as drought, salt, temperature or flooding, and as a by-product of over-excitation of photosynthetic systems. Thus, the internal environment of plants frequently contain an unfavorable redox balance. The beneficial organisms utilized by the present invention induce changes in plant gene expression including upregulation of entire pathways. Among those pathways that are enhanced are those that minimize accumulation of harmful ROS. In the presence of the beneficial organisms of the present invention, plants have an optimized internal redox environment (OIRE) that provides many benefits, Induction of the plant pathways leading to OIRE in the presence of stress appear to be an inducible primed system, just as resistance to diseases is. In addition, several lines of evidence indicate that the total photosynthetic machinery in plants is enhanced (Shoresh and Harman, 2008. Vargas, Mandawe, et al., 2009). Photosynthesis itself gives rise to ROS as a by-product of over-excitation of photosynthetic pigments, and so also results in ROS. Our strains upregulate the entire redox control pathway leading to OIRE, which is important for control of abiotic stresses and to provide additional photosynthate for plant growth.

The present invention entails a method comprising the use of a microbe inoculant or foliar spray to induce changes in plant gene expression that cause the plant to either resist or leverage the effects of an applied agricultural chemical. In one embodiment, Trichoderma afroharzianum strain (ATCC PTA97&9) is used to colonize corn roots followed by foliar treatment with 20% Methyl Violagen, otherwise known as the herbicide paraquat. 24 hours post spray, the T. afroharzianum-colonized plants show resistance to the herbicide spray. In another embodiment, corn plants colonized with T. afroharzianum strain (ATCC PTA9708), T. atroviridae strain (ATCC PTA9707) or a combination of the two, or treated with a Trichoderma metabolite, including 6-pentyl pyrone, harzianic acid, hydtra 1, harzinolide and/or 1-octene-3-ol, increases expression of genes in the reactive oxygen cycling pathway, the pathway that is responsible for reducing Paraquat to a non-toxic state. These plants were also shown to reduce oxidative damage in the foliar tissues as compared with a control group, thus resisting the herbicidal effect of the chemical.

In one embodiment, the present invention provides A method of conferring plant resistance to a control agent, comprising: selecting one or more plants; applying to the plant a biological mediator, wherein the biological mediator imparts resistance to the control agent; and separately, simultaneously or sequentially applying the control agent to the plants exposed to the biological mediator, wherein the plants exposed to the biological mediator possess increased resistance to the control agent compared to plants in the presence of the control agent that have not been exposed to the biological mediator. The plant may be corn, alfalfa, rice, wheat, barley, oats, rye, cotton, sorghum, sunflower, peanut, potato, sweet potato, bean, pea, chicory, lettuce, endive, cabbage, brussels sprout, beet, parsnip, turnip, cauliflower, broccoli, radish, spinach, onion, garlic, eggplant, pepper, celery, carrot, squash, pumpkin, zucchini, cucumber, apple, pear, melon, citrus, strawberry, grape, raspberry, pineapple, soybean, tobacco, tomato, maize, clover, sugarcane, Arabidopsis thaliana, Saintpaulia, petunia, pelargonium, poinsettia, chrysanthemum, carnation, zinnia, roses, snapdragon, geranium, zinnia, lily, daylily, Echinacea, dahlia, hosta, tulip, daffodil, peony, phlox, herbs, ornamental shrubs, ornamental grasses, switchgrass, and turfgrass, or any other plant or seed or crop, or combinations thereof.

In another embodiment, the biological mediator may include one or more of: SABREX, K5AS2, OMEGA, plant metabolites, microbial metabolites, fungal metabolites, T. harzianum, T. atroviride, T. gamsii, B. amyloliquifaciens, microbes, one or more bacterial species, fungal species, yeast species, cellular components, metabolites, compounds, surfactants, emulsifiers, metals, K1, K2, K3, K4, K5, AS1, AS2, AS3, AS4, AS5, Trichoderma viride strain NRRL B-50520, Trichoderma harzianum strain RR17Bc (ATCC accession number PTA 9708), Trichoderma harzianum strain F11Bab (ATCC accession number PTA 9709), Trichoderma atroviride strain WW10TC4 (ATCC accession number PTA 9707), Bacillus spp., Bacillus amyloliquifaciens strain AS2 and or any other compositions, mixtures, agents described herein, and/or combinations thereof.

In another embodiment the biological mediator is selected from the group consisting of Bradyrhizobium spp., Trichoderma spp., Bacillus spp., Pseudomonas spp, and Clonostachys spp. or any combination thereof. In yet another embodiment the biological mediator is selected from the group consisting of T. harzianum (T22), T. harzianum strain K2 (PTA ATCC 9708), T. atroviride strain K4 (PTA ATCC 9707), T. viride strain K5, T. viride strain NRRL B-50520, T. harzianum strain RR17Bc (ATCC accession number PTA 9708), T. harzianum strain F11Bab (ATCC accession number PTA 9709), T. atroviride strain WW10TC4 (ATCC accession number PTA 9707), Bacillus amloliqofaciens AS1, AS2 and/or AS3, or any combination thereof.

In another embodiment the control agent may include: one or more herbicides, one or more pesticides, Methyl Violagen (Paraquat), essential oils, clove oil, citrus oils, lemongrass oil, thyme oil, eugenol, thymol, citral, limonene, nonanoic acid, Roundup™, Scythe™, atrazine, glyphosate, glufosinate, Acceleron™, ipconazole, metalaxyl, trifloxystrobin (fungicides), clothianidin, chemical pesticides, fungicides, nematocides, Pasteuria nishizawae, Clariva™, Bacillus firmis strain 1-1582, VOTIVO™, MILSTOP™, sodium bicarbonate, potassium bicarbonate, Sylet Oil, Neem oil, Safer's Soaps™, and Reynoutria sachalinensi, and extracts thereof, and combinations thereof.

In one embodiment the biological mediator imparts resistance through upregulation of plant ROS cycling genes, altering plant gene expression antagonistic to those herbicides, and/or long term changes in plant gene expression via epigenetic regulation and/or signaling, and combinations thereof. The biological mediator may be a microbial agent, microbial metabolite, extract, and/or culture filtrate. The biological mediator may further be a fungal or bacterial microbe, or both.

In another embodiment, the microbial agent colonizes the root of the plant.

In one embodiment of the present invention the application of the biological mediator may include the following: broadcast application, aerosol application, spray-dried application, liquid, dry, powder, mist, atomized, semi-solid, gel, coating, lotion, linked or linker material, material, in-furrow application, spray application, irrigation, injection, dusting, pelleting, or coating of the plant or the plant seed or the planting medium with the agent. In another embodiment the metabolite or extracts or culture filtrate to mediate plant herbicide resistance fungus/bacterium.

In one embodiment the application of the control agent is selected from a means or group consisting of broadcast application, aerosol application, spray-dried application, liquid, dry, powder, mist, atomized, semi-solid, gel, coating, lotion, linked or linker material, material, in-furrow application, spray application, irrigation, injection, dusting, pelleting, or coating of the plant or the plant seed or the planting medium with the agent. The control agent may be a herbicide that targets plant protein, biochemical, enzymatic, and/or metabolic function.

In one embodiment of the present invention, a system is provided for conferring plant resistance to a control agent, comprising: one or more plants; at least one biological mediator that imparts resistance to the control agent; a means for localized application of the at least one biological mediator, wherein the localized application imparts systemic resistance to the control agent; and at least one control agent, wherein the at least one control agent is indiscriminately applied to the plant, and wherein the plants exposed to the biological mediator possess increased plant performance compared to plants in the presence of the control agent that have not been exposed to the biological mediator.

In one embodiment, the plant of such system may be corn, alfalfa, rice, wheat, barley, oats, rye, cotton, sorghum, sunflower, peanut, potato, sweet potato, bean, pea, chicory, lettuce, endive, cabbage, brussels sprout, beet, parsnip, turnip, cauliflower, broccoli, radish, spinach, onion, garlic, eggplant, pepper, celery, carrot, squash, pumpkin, zucchini, cucumber, apple, pear, melon, citrus, strawberry, grape, raspberry, pineapple, soybean, tobacco, tomato, maize, clover, sugarcane, Arabidopsis thaliana, Saintpaulia, petunia, pelargonium, poinsettia, chrysanthemum, carnation, zinnia, roses, snapdragon, geranium, zinnia, lily, daylily, Echinacea, dahlia, hosta, tulip, daffodil, peony, phlox, herbs, ornamental shrubs, ornamental grasses, switchgrass, and turfgrass, or any other plant or seed or crop, or combinations thereof.

In one aspect, the biological mediator may be plant metabolites, microbial metabolites, fungal metabolites, T. harzianum, T. atroviride, T. gamsii, B. amyloliquifaciens, microbes, one or more bacterial species, fungal species, yeast species, cellular components, metabolites, compounds, surfactants, emulsifiers, metals, strains K1, K2, K3, K4, K5, AS1, AS2, AS3, AS4, AS5, Trichoderma viride strain NRRL B-50520, Trichoderma harzianum strain RR17Bc (ATCC accession number PTA 9708), Trichoderma harzianum strain F11Bab (ATCC accession number PTA 9709), Trichoderma atroviride strain WW10TC4 (ATCC accession number PTA 9707), Bacillus spp., Bacillus amyloliquifaciens strain AS2 and or any other compositions, mixtures, agents described herein, and/or combinations thereof.

In one embodiment the biological mediator may be Bradyrhizobium spp., Trichoderma spp., Bacillus spp., Pseudomonas spp. and Clonostachys spp. or any combination thereof. In another embodiment, the biological mediator may be T. harzianum (T22), T. harzianum strain K2 (PTA ATCC 9708), T. atroviride strain K4 (PTA ATCC 9707), T. viride strain K5, T. viride strain NRRL B-50520, T. harzianum strain RR17Bc (ATCC accession number PTA 9708), T. harzianum strain F11Bab (ATCC accession number PTA 9709), T. atroviride strain WW0TC4 (ATCC accession number PTA 9707), Bacillus amloliqofaciens AS1, AS2 and/or AS3, or any combination thereof.

In one embodiment the biological mediator imparts resistance through upregulation of plant ROS cycling genes, altering plant gene expression antagonistic to those herbicides, and/or long term changes in plant gene expression via epigenetic regulation and/or signaling, and combinations thereof.

In one embodiment the biological mediator is a microbial agent, microbial metabolite, extract, and/or culture filtrate. The biological mediator may further be a fungal or bacterial microbe, or both. In one embodiment the microbial agent colonizes the root of the plant. The microbial agent or metabolite may be applied by any of broadcast application, aerosol application, spray-dried application, liquid, dry, powder, mist, atomized, semi-solid, gel, coating, lotion, linked or linker material, material, in-furrow application, spray application, irrigation, injection, dusting, pelleting, or coating of the plant or the plant seed or the planting medium with the agent.

The application of the control agent may be broadcast application, aerosol application, spray-dried application, liquid, dry, powder, mist, atomized, semi-solid, gel, coating, lotion, linked or linker material, material, in-furrow application, spray application, irrigation, injection, dusting, pelleting, or coating of the plant or the plant seed or the planting medium with the agent. In an exemplary embodiment, the control agent is a herbicide that targets plant protein, biochemical, enzymatic, and/or metabolic function.

Auxins are required plant hormones that when exogenously applied at high concentrations lead to unregulated growth and, in the case of herbicides, plant death. Biologicals such as Trichoderma and other beneficial microbes signal to their host plants via auxin and other plant hormones. Further, these microbes stimulate alterations in plant gene expression that include upregulation of additional plant hormones and the enzyme Glutathione S-transferase (GST) (Deng and Hatzios 2002, Sharma, Sahoo et al. 2014). GST belongs to a large gene family present in both plants and animals. In plants, the various forms of GST function to mitigate plant stress of most all types as well as regulate hormone-induced plant growth. Thus, colonization of a plant by the appropriate beneficial microbe can stimulate the plant to produce a massive root system via hormone signaling yet prevent the over stimulation perhaps by the over expression of GST. GST is also known to conjugate multiple classes of herbicides that are subsequent sequestered in the plant vacuole. Taking these factors into account, GST could be considered the nexus between multiple plant systems and an effective control point in herbicide safening.

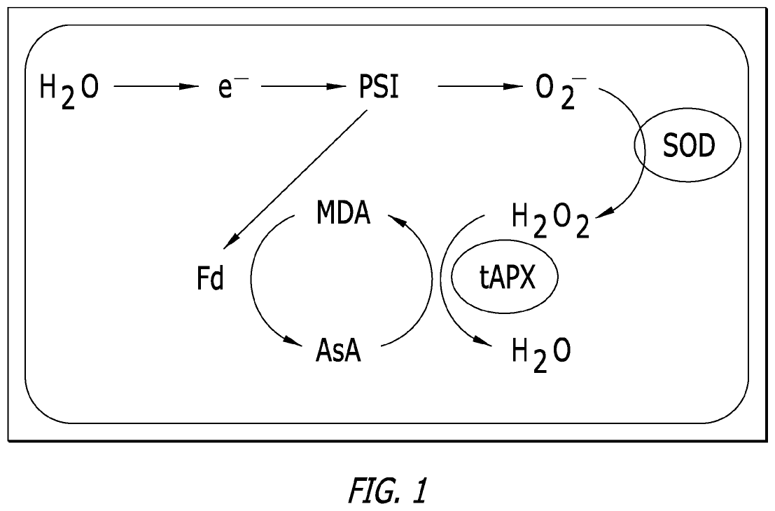

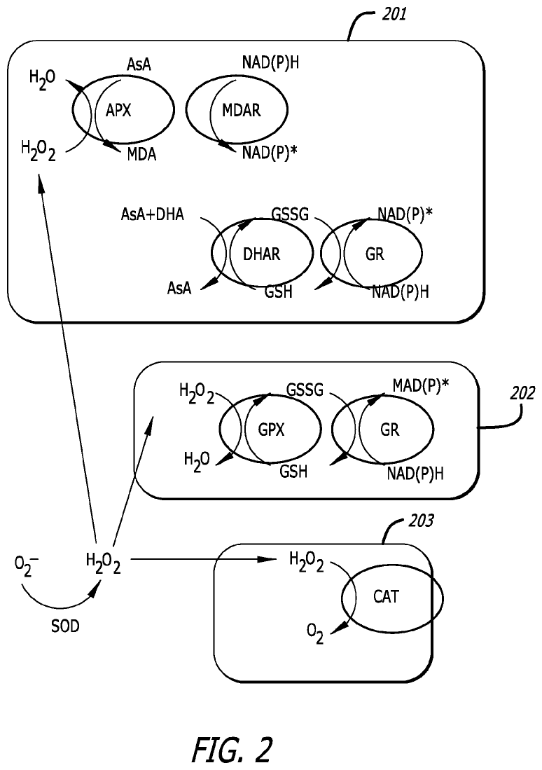

FIG. 1 and FIG. 2 show genes known to be upregulated by ABM Trichoderma strains (Mastouri, Bjorkman et al. 2012). Review of the literature indicates that upregulation of GST and control of hormone-induced plant growth are key features of several beneficial microbes (Ahmad, Hashem et al. 2015). FIG. 1 shows the water-water cycle (WWC) which, when effectively present, operates to scavenge active oxygens in chloroplasts, thus protecting from photoinhibition. The present invention addresses the two enzymes superoxide dismutase (SOD) and chloroplastic (thylakoid ascorbate peroxidase (tAPX)) hydrogen peroxide processing enzyme, both capable of upregulation by the compositions of the present invention. FIG. 2 shows other pathways comprising upregulated pathways within the Glutathione-ascorbate cycle 201, the GPX cycle 202 and the Catalase cycle 203. The circled enzymes: ascorbate peroxidase (APX), monodehydroascorbate reductase (MDAR), dehydroascorbate reductase (DHAR), and glutathione reductase (GR) 201, glutathione peroxidase (GPX) and GR 202, as well as catalase 203, are all shown to be upregulated by the compositions of the present invention.

Protoporphyrinogen oxidase inhibitor herbicides block catalysis of protoporphyrinogen to protoporphyrin IX which ultimately leads to the build-up of reactive oxygen species (ROS) in plant cells. Upregulation of the reactive oxygen cycling pathway is a known function of strains utilized with the present invention. Further, Glutathione S-transferase (GST) has been shown to bind several steps in the PPO pathway including some of the precursors leading to toxic ROS build-up (Lederer and Böger 2003). Trichoderma and other beneficial microbes have been shown to upregulate plant expression of several GST family members, including those mitigating plant stress responses (Ahmad, Hashem et al. 2015).

Plants, including non-gmo or otherwise unmodified plants are protected against paraquat or other herbicides with the same or similar modes of action having been colonized by microbial agents that induce upregulation of plant ROS cycling genes. This upregulation may be due to the activity of one or more colonizing microbial agents.

Plants, including non-gmo or otherwise unmodified plants will be protected against herbicides with other modes of action through colonization by microbial agents altering plant gene expression antagonistic to or compensating for those herbicides. This upregulation may be due to the activity of one or more colonizing microbial agents.

Plants, Non-gmo or otherwise unmodified plants will be protected against herbicides through application of microbial agent signaling molecules (metabolites). The mechanism of protection is the same as when the living microbial agent(s) is applied. These signal molecules may provide long term changes in plant gene expression via epigenetic means.

In one embodiment, OMEGA (a.i. 1-octene-3-ol) may contain 20 g of humate (Leondarite shale), 5 g of yeast extract, and 100 μl of 1-octene-3-ol (Sigma Chemical Co.) all suspended in 1 L of water, and with pH adjusted to 6.2. This mixture may be applied at, for example, the rate of 0.65 ml/kg of seeds.

The plant treatments may include T. harzianum strain K2 and T. atroviride strain K4 in a liquid formulation at 1×10\hat{ }9 colony forming units per ml. This product may be used at a rate of 0.7 ml/kg seeds, which is the commercially recommended rate. K5AS2, a seed treatment consisting of T. viride strain K5 and Bacillus amyloliquifaciens strain AS2, has also been developed and may be used in accordance with this disclosure. Seeds may be treated with this mixture at the rates as indicated above except that B. amyloiquifaciens may be used at the rate of 1×10\hat{ }10 colony forming units per ml. OMEGA seed treatment may also be used. This material contains as the active ingredient a Trichoderma metabolite that is strongly active in plant growth promotion and induction of plant disease resistance. This material is active at very low concentrations (less than 1 μl/seed) and has activity that persists on seedlings for at least two months after planting. The non-microbial agent may also contain a humate compound and a plant nutritive substance. This material confers many of the advantages of our living organisms. This product appears to be advantageous where individuals wish to use a biologically-incompatible formulation but still obtain the advantages of the microbial agents. Untreated controls may include standard fungicide/insecticide mixtures.

GMO plants can be designed that are protected against herbicides by optimizing expression of herbicide-antagonistic genes in the same manner as application of microbial agent(s) or their signaling molecules. For example, ROS cycling pathway genes can be put under the control of stronger or inducible promoters. Alternatively, microbial agent signaling molecules can be engineered into target plants under native, inducible, or constitutive promotor control. Thus, the trigger for protective gene expression modification will be controlled from the plant without the necessity of a microbial agent or exogenous application of a microbial agent signaling molecule.

In this manner, plants can be protected against existing herbicides, such as paraquat, that target plant cell functions upregulated by microbial agents. The effects of other herbicides can also be controlled when their modes of action attack microbial agent-augmented cell functions.

New herbicides can be developed targeting plant cell functions; proteins; and biochemical, enzymatic and metabolic activities upregulated or otherwise augmented by colonization by microbial agent or application of microbial agent signaling molecule. GMO plants can be created to supply signaling molecules from the plant genome or alter specific plant gene promoter sequences.

GMO plants can be created wherein microbial agent signaling molecule upregulate expression of novel gene sets by altering said gene promoter sequences, plant receptor molecules, plant receptor-signal transduction interactions. Therefore, the same microbial agent will trigger a novel set of gene expression changes. This novel set of genes can mitigate the effects of existing, known, or newly designed herbicides.

### Examples

The present invention is further illustrated by the following examples, which should not be construed as limiting in any way.

### Example 1. Use of Methyl Violagen (Paraquat) to Assay a Plant's Ability to Regulate ROS

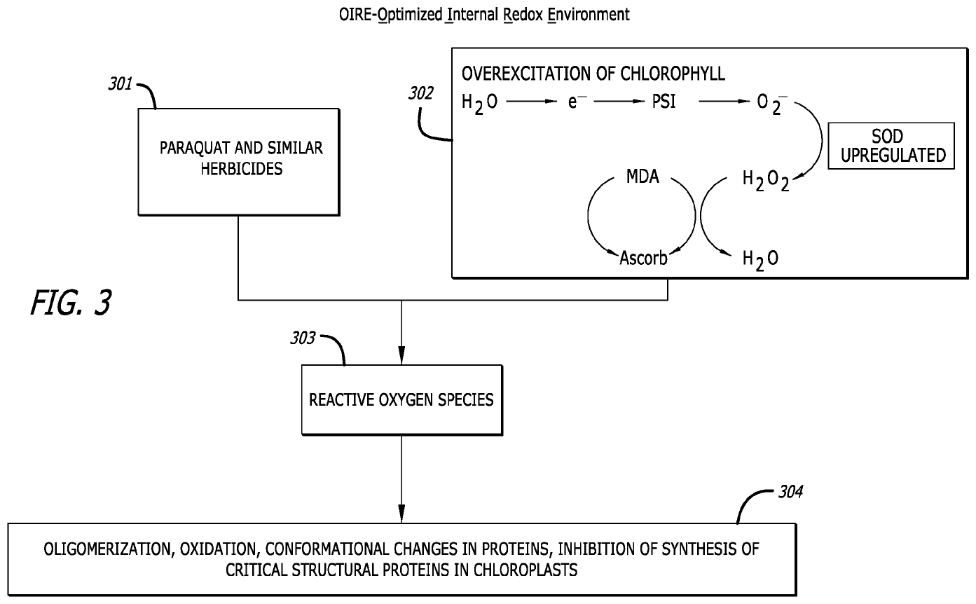

Leaf disc assays are used to identify a plant's ability to reduce ROS through antioxidant activity. Plant samples are submerged in osmoticum amended with 1 uM Methyl Violagen (Paraquat) and dark adapted for 20 hours. Subsequent light exposure activates ROS production and results in membrane leakage owing to massive cellular damage. Changes in osmoticum conductance over the pre-treatment baseline reflect the plant's ability to protect against this cellular damage and limit leakage of cell contents. An exemplary flow of the optimized internal redox environment (OIRE) is set forth in FIG. 3. Paraquat 301 causes an over excitation of chlorophyll 302, resulting in the creation of reactive oxygen species (ROS) 303. The increased presence of ROS results in several conditions 304: oligomerization, oxidation, conformational changes in proteins, and inhibition of synthesis of critical structural proteins in chloroplasts. The compositions of the present invention upregulate the entire pathways of antioxidant recycling, resulting in minimization of damage to ROS production, which serves as the basis for OIRE and increase of functional photosynthetic efficiency.

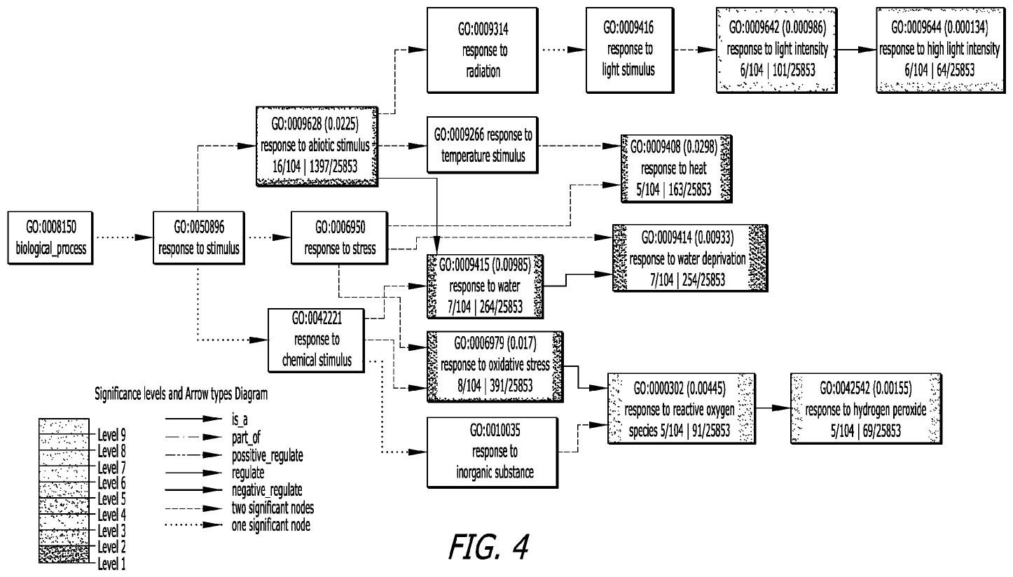

FIG. 4. Shows the diagrammatic output of BLAST2GO analysis of RNAseq data showing that genes in the reactive oxygen cycling pathway are upregulated in a composition using a combination of T. afroharzianum, ATCC PTA9708 and T. atroviridae, ATCC PTA9707), for exemplary purposes.

### Example 2. Use of Microbial Agents and Microbial Signaling Molecule (Metabolite) to Control Methyl Violagen (Paraquat) Spray Damage on Silage Corn

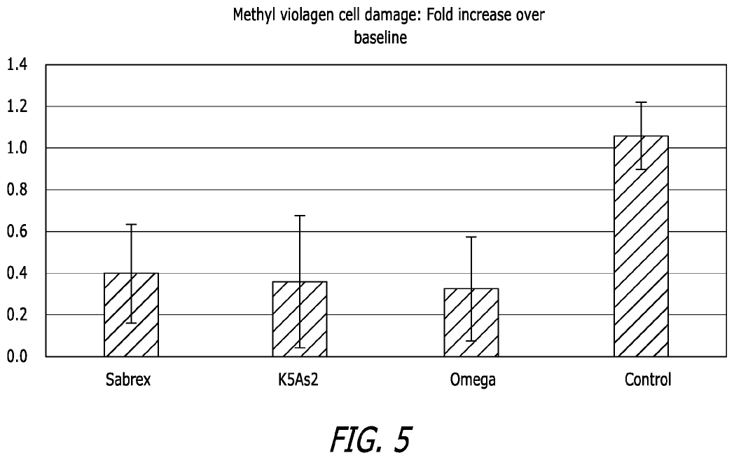

FIG. 5 shows the response of corn plants to Methyl Violagen treatment when treated with microbial agent signaling molecules (OMEGA) or untreated (Control), in a greenhouse demonstration of strain protection against Paraquat. OMEGA is a Trichoderma volatile organic compound signaling molecule formulated such that it is stabilized on seed.

### Example 3. Use of Microbial Agents Identified Herein to Control Methyl Violagen (Paraquat) Spray Damage on Corn Seedling

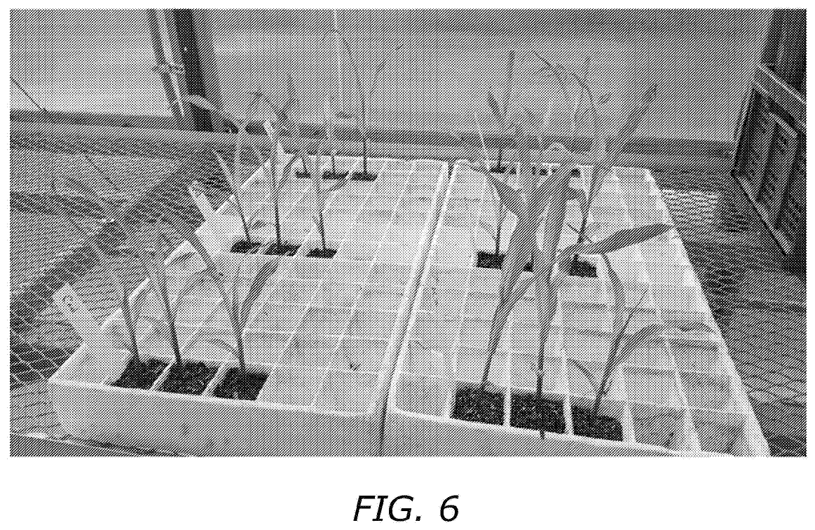

FIG. 6 shows the response of corn plants to Methyl Violagen treatment when colonized by microbial agents (SABREX, K5AS2) or untreated (Control), in a greenhouse demonstration of strain protection against Paraquat. Control is in the foreground, left of FIG. 6. Remaining plants have been colonized with Trichoderma strains in addition to the paraquat treatment. SABREX contains two different strains of Trichoderma (T. harzianum+T. atroviride). K5AS2 contains a single Trichoderma strain (T. gamsii) and a single Bacillus strain (B. amyloliquifaciens). All treatments show a significant fold reduction vs the control treatment. Further this demonstrates that mitigation of ROS damage can be affected by use of fungal agents, bacterial agents, or fungal signaling molecules.

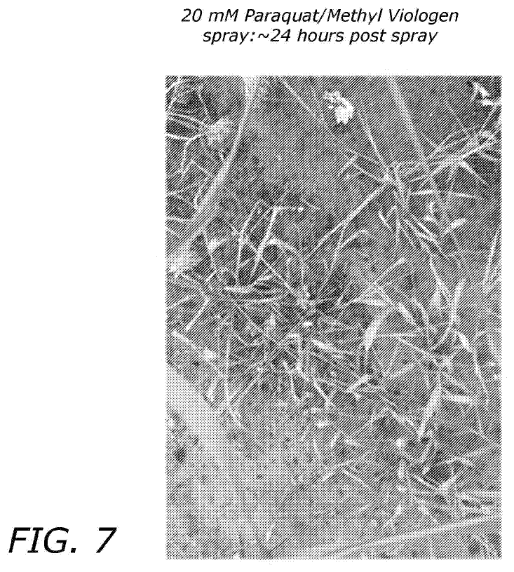

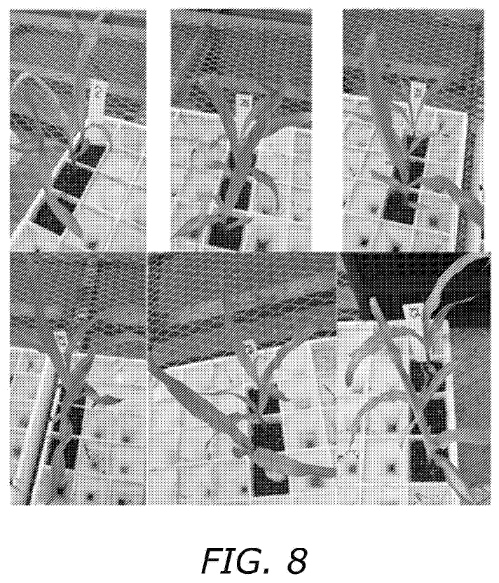

Additional data relating to the present invention is shown in FIG. 7, wherein the recovery of greenhouse plants is demonstrated from gh spray of paraquat at 24 hours post spray. Plants in the pink cordoned area show the complete killing effect of the Paraquat application on a weedy target. Turning to FIG. 8, recovery of replicates of plants using compositions of the present invention is shown. The control is in the upper left and the remaining plants are colonized with single Trichoderma strains, with 3 replicate plants per strain.

The present invention is not to be limited in terms of the particular embodiments described in this application, which are intended as single illustrations of individual aspects of the invention. Many modifications and variations of this invention can be made without departing from its spirit and scope, as will be apparent to those skilled in the art. Functionally equivalent methods and apparatuses within the scope of the invention, in addition to those enumerated herein, will be apparent to those skilled in the art from the foregoing descriptions. Such modifications and variations are intended to fall within the scope of the appended claims. The present invention is to be limited only by the terms of the appended claims, along with the full scope of equivalents to which such claims are entitled. It is to be understood that this invention is not limited to particular methods, reagents, compounds compositions or biological systems, which can, of course, vary. It is also to be understood that the terminology used herein is for the purpose of describing particular embodiments only, and is not intended to be limiting. In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof, Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth. All patents, patent applications, provisional applications, and publications referred to or cited herein are incorporated by reference in their entirety, including all figures and tables, to the extent they are not inconsistent with the explicit teachings of this specification.

### REFERENCES

Altschul, S. F., Gish, W., Miller, W., Myers, E. W. & Lipman, D. J. (1990) “Basic local alignment search tool.” J. Mol. Biol. 215:403-410.
Mastouri et al 2010. Phytopath. Seed treatment w/T. harzianum alleviates biotic, abiotic, physiolo . . .
Shoresh and Harman 2008. Plant Physiol. Mol Basis of shoot responses . . . prot approach.
Fujibe, T., Saji, H., Arakawa, K., Yabe, N., Takeuchi, Y., and Yamamoto, K. T. 2004. A methyl viologen-resistant mutant of Arabidopsis, which is allelic to ozone-sensitive red1, is tolerant to supplemental ultraviolet B irradiation. Plant Physiol. 134:275-285.
Ahmad, P., A. Hashem, E. F. Abd-Allah, A. A. Alqarawi, R. John, D. Egamberdieva and S. Gucel (2015). “Role of Trichoderma harzianum in mitigating NaCl stress in Indian mustard (Brassica juncea L) through antioxidative defense system.” Front Plant Sci 6: 868.
Deng, F. and K. K. Hatzios (2002). “Characterization and Safener Induction of Multiple Glutathione S-Transferases in Three Genetic Lines of Rice.” Pesticide Biochemistry and Physiology 72(1): 24-39.
Lederer, B. and P. Böger (2003). “Binding and protection of porphyrins by glutathione S-transferases of Zea mays L.” Biochimica et Biophysica Acta (BBA)—General Subjects 1621(2): 226-233.
Mastouri, F., T. Bjorkman and G. E. Harman (2012). “Trichoderma harzianum enhances antioxidant defense of tomato seedlings and resistance to water deficit.” Mol Plant Microbe Interact 25(9): 1264-1271.
Sharma, R., A. Sahoo, R. Devendran and M. Jain (2014). “Over-expression of a rice tau class glutathione s-transferase gene improves tolerance to salinity and oxidative stresses in Arabidopsis.” PLoS One 9(3): e92900.

1. A method of conferring plant resistance to a control agent, comprising:
a. selecting one or more plants;
b. applying to the plant a biological mediator, wherein the biological mediator imparts resistance to the control agent; and
c. separately, simultaneously or sequentially applying the control agent to the plants exposed to the biological mediator, wherein the plants exposed to the biological mediator possess increased resistance to the control agent compared to plants in the presence of the control agent that have not been exposed to the biological mediator.

2. The method of claim 1, wherein the one or more plants is selected from the group consisting of corn, alfalfa, rice, wheat, barley, oats, rye, cotton, sorghum, sunflower, peanut, potato, sweet potato, bean, pea, chicory, lettuce, endive, cabbage, brussels sprout, beet, parsnip, turnip, cauliflower, broccoli, radish, spinach, onion, garlic, eggplant, pepper, celery, carrot, squash, pumpkin, zucchini, cucumber, apple, pear, melon, citrus, strawberry, grape, raspberry, pineapple, soybean, tobacco, tomato, maize, clover, sugarcane, Arabidopsis thaliana, Saintpaulia, petunia, pelargonium, poinsettia, chrysanthemum, carnation, zinnia, roses, snapdragon, geranium, zinnia, lily, daylily, Echinacea, dahlia, hosta, tulip, daffodil, peony, phlox, herbs, ornamental shrubs, ornamental grasses, switchgrass, and turfgrass, or any other plant or seed or crop, or combinations thereof.

3. The method of claim 1, wherein the biological mediator is selected from the group consisting of Bradyrhizobium spp., Trichoderma spp., Bacillus spp., Pseudomonas spp. and Clonostachys spp. or any combination thereof.

4. The method of claim 1, wherein the biological mediator is selected from the group consisting of T. harzianum (T22), T. harzianum strain K2 (PTA ATCC 9708), T. atroviride strain K4 (PTA ATCC 9707), T. viride strain K5, T. viride strain NRRL B-S0S20, T. harzianum strain RR17Bc (ATCC accession number PTA 9708), T. harzianum strain F11Bab (ATCC accession number PTA 9709), T. atroviride strain WW10TC4 (ATCC accession number PTA 9707), Bacillus amloliqofaciens AS1, AS2 and/or AS3, or any combination thereof.

5. The method of claim 1, wherein the control agent is selected from the group consisting of one or more herbicides, one or more pesticides, Methyl Violagen (Paraquat), essential oils, clove oil, citrus oils, lemongrass oil, thyme oil, eugenol, thymol, citral, limonene, nonanoic acid, SCYTHE™, atrazine, glyphosate, glufosinate, ACCELERON™, ipconazole, metalaxyl, trifloxystrobin (fungicides), clothianidin, chemical pesticides, fungicides, nematocides, Pasteuria nishizawae, Clariva™, Bacillus firmis strain I-1582, VOTIVO™, MILSTOP™, sodium bicarbonate, potassium bicarbonate, Sylet Oil, Neem oil, SAFER'S SOAPS™, and Reynoutria sachalinensi, and extracts thereof, and combinations thereof.

6. The method of claim 1, wherein the biological mediator imparts resistance through upregulation of plant ROS cycling genes, altering plant gene expression antagonistic to those herbicides, and/or long term changes in plant gene expression via epigenetic regulation and/or signaling, and combinations thereof.

7. The method of claim 1, wherein the biological mediator is a microbial agent, microbial metabolite, extract, and/or culture filtrate.

8. The method of claim 7, wherein the biological mediator is a fungal or bacterial microbe, or both.

9. The method of claim 8, wherein the microbial agent colonizes the root of the plant.

10. The method of claim 1, wherein the application of the biological mediator is selected from a means or group consisting of broadcast application, aerosol application, spray-dried application, liquid, dry, powder, mist, atomized, semi-solid, gel, coating, lotion, linked or linker material, material, in-furrow application, spray application, irrigation, injection, dusting, pelleting, or coating of the plant or the plant seed or the planting medium with the agent.

11. The method of claim 10, wherein the metabolite or extracts or culture filtrate to mediate plant herbicide resistance fungus/bacterium.

12. The method of claim 1, wherein the application of the control agent is selected from a means or group consisting of broadcast application, aerosol application, spray-dried application, liquid, dry, powder, mist, atomized, semi-solid, gel, coating, lotion, linked or linker material, material, in-furrow application, spray application, irrigation, injection, dusting, pelleting, or coating of the plant or the plant seed or the planting medium with the agent.

13. The method of claim 1, wherein the control agent is a herbicide that targets plant protein, biochemical, enzymatic, and/or metabolic function.

14. A system for conferring plant resistance to a control agent, comprising:
a. one or more plants;
b. at least one biological mediator that imparts resistance to the control agent;
c. a means for localized application of the at least one biological mediator, wherein the localized application imparls systemic resistance to the control agent; and d. at least one control agent, wherein the at least one control agent is indiscriminately applied to the plant, and wherein the plants exposed to the biological mediator possess increased plant performance compared to plants in the presence of the control agent that have not been exposed to the biological mediator.

15. The system of claim 14, wherein the one or more plants is selected from the group consisting of corn, alfalfa, rice, wheat, barley, oats, rye, cotton, sorghum, sunflower, peanut, potato, sweet potato, bean, pea, chicory, lettuce, endive, cabbage, brussels sprout, beet, parsnip, turnip, cauliflower, broccoli, radish, spinach, onion, garlic, eggplant, pepper, celery, carrot, squash, pumpkin, zucchini, cucumber, apple, pear, melon, citrus, strawberry, grape, raspberry, pineapple, soybean, tobacco, tomato, maize, clover, sugarcane, Arabidopsis thaliana, Saintpaulia, petunia, pelargonium, poinsettia, chrysanthemum, carnation, zinnia, roses, snapdragon, geranium, zinnia, lily, daylily, Echinacea, dahlia, hosta, tulip, daffodil, peony, phlox, herbs, ornamental shrubs, ornamental grasses, switchgrass, and turfgrass, or any other plant or seed or crop, or combinations thereof.

16. The system of claim 14, wherein the biological mediator is selected from the group consisting of Bradyrhizobium spp., Trichoderma spp., Bacillus spp., Pseudomonas spp. and Clonoslachys spp. or any combination thereof.

17. The system of claim 14, wherein the biological mediator is selected from the group consisting of T. harzianum (T22), T. harzianum strain K2 (PTA ATCC 9708), T. atroviride strain K4 (PTA ATCC 9707), T. viride strain K5, T. viride strain NRRL B-SOS20, T. harzianum strain RR17Bc (ATCC accession number PTA 9708), T. harzianum strain Fl IBab (ATCC accession number PTA 9709), T. atroviride strain WW10TC4 (ATCC accession number PTA 9707), Bacillus amloliqofaciens AS1, AS2 and/or AS3, or any combination thereof.

18. The system of claim 14, wherein the control agent is selected from the group consisting of one or more herbicides, one or more pesticides, Methyl Violagen (Paraquat), essential oils, clove oil, citrus oils, lemongrass oil, thyme oil, eugenol, thymol, citral, limonene, nonanoic acid, SCYTHE™, atrazine, glyphosate, glufosinate, Acceleron™, ipconazole, metalaxyl, trifloxystrobin (fungicides), clothianidin, chemical pesticides, fungicides, nematocides, Pasteuria nishizawae, CLARIVA™, Bacillus firmis strain 1-1582, VOTIVO™, MILSTOP™, sodium bicarbonate, potassium bicarbonate, Sylet Oil, Neem oil, SAFER'S SOAPS™, and Reynoutha sachalinensi, and extracts thereof, and combinations thereof.

19. The system of claim 14, wherein the localized application is a seed treatment or root application of the at least one biological mediator.

20. The system of claim 19, wherein the root application is a sustained colonization of the biological mediator.

21. The system of claim 20, wherein the biological mediator is a microbial agent.

22. The system of claim 14, wherein the biological mediator imparts resistance through upregulauon of plant ROS cycling genes, altering plant gene expression antagonistic to those herbicides, and/or long term changes in plant gene expression via epigenetic regulation and/or signaling, and combinations thereof.

23. The system of claim 14, wherein the biological mediator is a microbial agent, microbial metabolite, extract, and/or culture filtrate.

24. The system of claim 23, wherein the biological mediator is a fungal or bacterial microbe, or both.

25. The system of claim 24, wherein the microbial agent colonizes the root of the plant.

26. The system of claim 14, wherein the application of the microbial agent or metabolite is selected from a means or group consisting of broadcast application, aerosol application, spray-dried application, liquid, dry, powder, mist, atomized, semi-solid, gel, coating, lotion, linked or linker material, material, in-furrow application, spray application, irrigation, injection, dusting, pelleting, or coating of the plant or the plant seed or the planting medium with the agent.

27. The system of claim 14, wherein the application of the control agent is selected from a means or group consisting of broadcast application, aerosol application, spray-dried application, liquid, dry, powder, mist, atomized, semi-solid, gel, coating, lotion, linked or linker material, material, in-furrow application, spray application, irrigation, injection, dusting, pelleting, or coating of the plant or the plant seed or the planting medium with the agent.

28. The system of claim 14, wherein the control agent is a herbicide that targets plant protein, biochemical, enzymatic, and/or metabolic function.
